(19) United States
(12) Patent Application Publication
(10) Pub. No.: US 2025/0147644 A1
(43) Pub. Date: May 8, 2025

(54) GENERATING A PREVIEW TILE FOR A CONTENT ITEM IN A CONTENT MANAGEMENT SYSTEM

(71) Applicant: Dropbox, Inc., San Francisco, CA (US)

(72) Inventors: Christopher Meeks, Austin, TX (US); Paul Kim, Austin, TX (US)

(21) Appl. No.: 18/502,830

(22) Filed: Nov. 6, 2023

(51) Int. Cl. G06F 3/04842; G06F 16/16

(52) U.S. Cl. CPC G06F 3/04842; G06F 16/16

(57) ABSTRACT

The present disclosure relates to systems, non-transitory computer-readable media, and methods for generating and displaying a preview tile. In particular, in one or more embodiments, the disclosed systems select content item segments from a content item stored for a content management system and generate a preview tile by generating hotspot frames that reflect digital content in the content items segments. Further, in one or more embodiments, the disclosed systems provide the preview tile on a client device and, based on an input location relative to the preview tile, determine a hotspot frame to display within the preview tile.

### BACKGROUND

Recent years have seen significant improvements in the capabilities and capacities for storing digital content items. For example, many conventional systems can store a multitude of digital content items, which can be easily managed through connected applications and interfaces. In particular, conventional systems render interfaces for identifying and accessing content items by generating an icon with a preview of the item, which often includes an image or other pictorial representation of the content item. Although conventional systems can store and manage digital content items, conventional systems exhibit a number of technical deficiencies with regard to displaying information about the content item in a preview icon.

For instance, many conventional systems are computationally inefficient. In particular, while conventional systems represent content items with icons, conventional systems still require opening a document in order to identify content, data, and/or information found within the content item. For instance, conventional systems often render a content icon from a specific portion of the content item, such as capturing an image of the first portion of the content item (e.g., the first slide, first image from a digital video, or first page of a document) in order to generate a pictorial representation of the content item. However, by attempting to depict the possibly varied and vast amount of information within a content item through only a single portion or representation of the content item, conventional systems often require users to make multiple graphical user interface navigation steps to both open the document and browse through the document in order to identify if they have the desired content item. Thus, conventional systems require bandwidth and processing time not only to render and display the content item-which in itself can be costly for large content items—but also additional bandwidth and processing time to render and display additional content items if a user does not find the desired information or content. These computational inefficiencies are further compounded when a document is stored within a cloud storage system and the document must be downloaded from a server to a client device to perform the navigational steps necessary for a user to identify the content.

In addition to their computational inefficiencies, conventional systems are also navigationally inefficient. Specifically, since conventional systems display minimal information about a content item in a preview icon, users must access multiple content items in multiple interfaces to locate the desired data and/or content, such as to find specific information in a content item. Indeed, because some existing systems render only a single frame from the first portion of a content item, existing systems require users to open additional interfaces in order to navigate through a content item to find the desired information. For example, conventional systems often require one interface to view the preview icon of the content item, additional interfaces to open and/or navigate through a content item, and even more additional interfaces for additional content items in order to locate the desired data and/or content.

Moreover, conventional systems are inflexible. As mentioned, conventional systems render a single icon to depict the content of a content item, often capturing an image of the first page, frame, or image from a content item to use as an icon to represent the entirety of the content item. Indeed, conventional systems often capture an image of the first portion of a content item regardless of the length and/or size of the content item. Moreover, conventional systems are often limited to depicting only the first portion of the content because they cannot identify whether another portion of the content item would more accurately depict the content item. These, along with additional problems and issues, exist with regard to conventional systems.

### BRIEF SUMMARY

This disclosure describes one or more embodiments of systems, methods, and non-transitory computer-readable storage media that provide benefits and/or solve one or more of the foregoing and other problems in the art. For instance, the disclosed systems generate a preview tile for a content item comprising hotspots of selected segments of a content item and display a hotspot based on an input location within the preview tile. In some embodiments, the disclosed systems select segments of a content item stored in a content management system and generate a preview tile by generating hotspots to reflect the digital content within the content item segments. The disclosed systems further display the preview tile on a client device and determine a hotspot frame to display based on an input location in the preview tile (e.g., cursor location), then update the preview tile to display additional hotspots based on additional input locations (e.g., moving a cursor). In one or more embodiments, the disclosed systems select content segments based on information associated with the content item and/or a user account associated with the content item, such as previous or anticipated user interactions with the content item, timestamps, or size of the content item. Embodiments of the present disclosure provide benefits and/or solve one or more of the foregoing or other problems in the art with systems, non-transitory computer-readable media, and methods for generating a preview tile.

### BRIEF DESCRIPTION OF THE DRAWINGS

The detailed description provides one or more embodiments with additional specificity and detail through the use of the accompanying drawings, as briefly described below.

FIG. 1 illustrates a block diagram of an environment in which the preview tile generation system can operate in accordance with one or more embodiments.

FIG. 2 illustrates an example diagram of an overview of the preview tile generation system generating a preview tile in accordance with one or more embodiments.

FIG. 3 illustrates an example diagram of the preview tile generation system displaying a hotspot frame within a preview tile based on an input location in accordance with one or more embodiments.

FIG. 4 illustrates an example diagram of the preview tile generation system selecting content item segments from a content item in accordance with one or more embodiments.

FIGS. 5A-5C illustrate example diagrams of the preview tile generation system generating a preview tile for various types of content items in accordance with one or more embodiments.

FIG. 6 illustrates an example of the preview tile generation system displaying hotspot frames in preview tile based on user account in accordance with one or more embodiments.

FIG. 7 illustrates an example diagram of assigning locations within the preview tile to hotspot frames in accordance with one or more embodiments.

FIG. 8 illustrates the preview tile generation system accessing a content item based on the input location in the preview tile in accordance with one or more embodiments.

FIG. 9 illustrates a flowchart of a series of acts for generating a preview tile in accordance with one or more embodiments.

FIG. 10 illustrates a block diagram of an example computing device for implementing one or more embodiments of the present disclosure.

FIG. 11 illustrates a network environment of a content management system in accordance with one or more embodiments.

### DETAILED DESCRIPTION

This disclosure describes one or more embodiments of a preview tile generation system that generates and displays a preview tile comprising hotspots for easily scrubbing through frames in order to easily identify (and access) digital content. In particular, the preview tile generation system intelligently selects segments of a content item stored in a content management system and generates the preview tile by generating a set of hotspots that, upon detecting input from a client device within the preview tile (e.g., through cursor placement), will display a hotspot frame that reflects the digital content in a segment of the content item. Specifically, as the preview tile generation system identifies additional input from the client device at additional input locations within the preview tile, the preview tile generation system displays additional hotspot frames within the preview tile that depict digital content from an additional segment of the content item. Moreover, the preview tile generation system can identify meaningful segments of digital content across multiple types of content items, allowing for quick and easy identification of desired content, regardless of content type, without the need to open and/or sift through content items.

As just mentioned, the preview tile generation system selects segments of a content item. In particular, the preview tile generation system selects meaningful portions of content from a variety of content items. Specifically, the preview tile generation system intelligently selects a set of content item segments for each content item to include within the preview, with each segment of the content item comprising a portion of the digital content within the content item. For example, the preview tile generation system selects content item segments based on the content item (e.g., the size of the content item or the type of content item). Additionally, as another example, the preview tile generation system selects content item segments based on recency (e.g., through a timestamp of when a content item was opened or edited). As a further example, the preview tile generation system selects content item segments by selecting content item segments from portions of content that were recently (or commonly) edited.

Moreover, in one or more embodiments, the preview tile generation system selects content item segments based on identifying portions of the content item that a client device will likely identify (or access). For example, in some cases, the preview tile generation system utilizes a content prioritization machine-learning model to identify a likelihood that a client device will access digital content within the content item and selects content item segments based on the likelihood. In other cases, the preview tile generation system identifies that a content item corresponds to a requested user action from the client device and selects content item segments comprising the requested user action. In further cases, the preview tile generation system identifies that the content item is associated with a collaborating user account and selects content item segments from content items accessed by the client device (or user account associated with the client device).

As mentioned, the preview tile generation system generates the preview tile by generating a set of hotspot frames. Specifically, the preview tile generation system generates a set of hotspot frames that reflect the digital content in the selected content item segments. For example, the content can be an image or other graphical depiction that visually represents the content item segment and, when scrubbed through on the preview tile, visually depicts the contents of the content item.

As also mentioned, the preview tile generation system determines a hotspot frame to display within the preview tile based on an input location. In particular, in one or more embodiments, the preview tile generation system determines a hotspot frame to display based on hotspot frames corresponding to input locations within the preview tile. Specifically, the preview tile generation can associate or identify hotspot frame locations within the preview tile and associate a hotspot frame with each hotspot frame location so that, upon receiving an input location corresponding to the hotspot frame location, the preview tile generation system can quickly display the hotspot frame associated with the hotspot frame location. The preview tile generation system can also update the preview tile to display additional hotspot frames based on updated input locations relative to the preview tile (e.g., based on detecting a change in the positioning of a cursor within the preview tile).

As suggested above, the preview tile generation system can provide a variety of technical advantages over conventional systems. For example, the preview tile generation system provides improved efficiency and flexibility in relation to identifying and accessing content items or digital content within a content item. Regarding computing efficiency, as opposed to existing systems that do not adequately relay the digital content within a content item and instead require excessive amounts of bandwidth and processing time to render and display content items in order to identify or access specific digital content within a content item, the preview tile generation system relays information about content items within a preview tile. Indeed, by intelligently sampling content item segments that represent the content item as a whole and/or content segments that represent portions of the content item that would quickly and easily identify the content item to the user, the preview tile generation system can direct a user to the desired content item or portion of the content item without using bandwidth and processing time required to render and/or open the content item. For large content items (e.g., large digital video files or long documents), which require massive amounts of processing time and bandwidth to open and render, the efficiency is even more pronounced, as a user may identify the content item without the need to open it.

In addition to improving navigational efficiency, the preview tile generation system also improves navigational efficiency. For example, unlike conventional systems that require a user to open each content item they anticipate contains the content they desire to access, the preview tile generation system requires fewer interface interactions. Indeed, because the preview tile generation system can generate a preview tile within an existing user interface (e.g., of a content management system), there is no need for the system to render additional user interfaces through which a user must navigate to find desired digital content. Moreover, because the preview tile generation system identifies and selects portions of digital content that are likely to be relevant to the user, fewer interface interactions are needed for the user to find the desired digital content.

Moreover, the preview tile generation system improves flexibility relative to convention systems. Unlike conventional systems that are only able to render a single icon to depict the digital content within a content item, the preview tile generation system can intelligently identify and display multiple portions of the digital content from the content item. Indeed, by identifying multiple aspects of the content item and, in some cases, utilizing machine-learning to anticipate portions of the content item that are likely to be important to the user, the preview tile generation system can tailor the preview tile to best reflect the digital content displayed to the user.

As illustrated by the foregoing discussion, the present disclosure utilizes a variety of terms to describe the features and advantages of the preview tile generation system. Additional detail is now provided regarding the meaning of such terms. For example, as used herein, the term “content item” refers to a digital object or a digital file that includes information interpretable by a computing device (e.g., a client device) to present information to a user. A content item can include a folder or a file such as a digital text file, a digital image file, a digital audio file, a webpage, a website, a digital video file, a web file, a link, a digital document file, or some other type of file or digital object. A content item can have a particular file type or file format, which may differ for different types of digital content items (e.g., digital documents. digital images, digital videos, or digital audio files). In some cases, a content item can refer to a remotely stored (e.g., cloud-based) item or a link (e.g., a link to a cloud-based item or a web-based content item) and/or a content clip that indicates (or links) a discrete selection or segmented portion of content from a webpage or some other content item or source. A content item can be editable or otherwise modifiable and can also be sharable from one user account (or client device) to another. In some cases, a content item is modifiable by multiple user accounts (or client devices) simultaneously and/or at different times.

In addition, as used herein, the term “content item segment” refers to a portion of a digital content item. In particular, the term content item segment can refer to a distinct and self-contained portion of digital data from a content item comprising a specific subset of the digital content in the content item. To illustrate, a content item segment can comprise a portion of text, images, audio, or other data from the content item. A content item segment can comprise digital content from the content item that reflects a portion of a content item that a client device will likely access, such as frequently or recently accessed portions of the content item or recently edited portions of a content item.

Further, as used herein, the term “preview tile” refers to a graphical representation or icon associated with a content item that represents the digital content in a content item. In particular, the term preview tile can refer to a collection of images or other graphical representations that assist users in identifying and understanding the digital contents of a content item. To illustrate, the preview tile can be rendered in place of or in addition to an icon representing the content item in an interface of a content management system. A preview tile can be integrated into the interface or can be an interface element within a content management system interface.

Moreover, as used herein, the term “hotspot frame” refers to a defined area or region of a user interface that is configured to identify or react when acted upon or interacted with through a client device. In particular, the term hotspot frame can refer to a portion of an interface or an interface element with identified locations that, when acted upon by a client device, will render digital content from a content item. To illustrate, a hotspot frame can be a representation of digital content as an image or other pictorial representation of the digital content within the content item.

In addition, as used herein, the term “input location” refers to a specific point of reference or position within a digital interface where user input or actions are being directed. In particular, input location refers to a defined area or region of a user interface that is configured to identify or react in a specified way when acted upon (or interacted with) through a client device. For example, an input location can refer to a location within a digital interface or preview tile of a cursor relative to the digital interface or preview tile. Moreover, an input location can be defined as coordinates (e.g., X, Y coordinates) within the digital interface or preview tile. An input location can be received (or changed) based on the location of a cursor and/or through moving the input device associated with the cursor, such as a mouse or a keyboard.

Moreover, as used herein, the term “hotspot frame location” refers to a specific point or position within a preview tile corresponding to a hotspot frame. In particular, hotspot frame location refers to an input location that is associated with a hotspot frame. For example, a hotspot frame location refers to a set of coordinates that, when interacted with by a client device, will render (or cause a system to render) a hotspot frame. To illustrate, a system can receive a cursor location in a preview tile that corresponds to a hotspot frame location and display a hotspot frame associated with the hotspot frame location.

As used herein, the term “machine-learning model” refers to a computer algorithm or a collection of computer algorithms that automatically improve for a particular task through iterative outputs or predictions based on the use of data. For example, a machine learning model can utilize one or more learning techniques to improve accuracy and/or effectiveness. Example machine learning models include various types of neural networks, decision trees, support vector machines, linear regression models, and Bayesian networks. In some embodiments, the morphing interface system utilizes a large language machine-learning model in the form of a neural network. A content-prioritizing machine-learning model can refer to a machine-learning model that is trained or tuned to identify digital content in a content item that a client device is likely to access.

Relatedly, the term “neural network” refers to a machine-learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., likelihood that a client device will access a content item) based on a plurality of inputs provided to the neural network. In some cases, a neural network refers to an algorithm (or set of algorithms) that implements deep learning techniques to model high-level abstractions in data. A neural network can include various layers, such as an input layer, one or more hidden layers, and an output layer that each perform tasks for processing data. For example, a neural network can include a deep neural network, a convolutional neural network, a transformer neural network, a recurrent neural network (e.g., an LSTM), a graph neural network, or a generative adversarial neural network. Upon training, such a neural network may become a large language model.

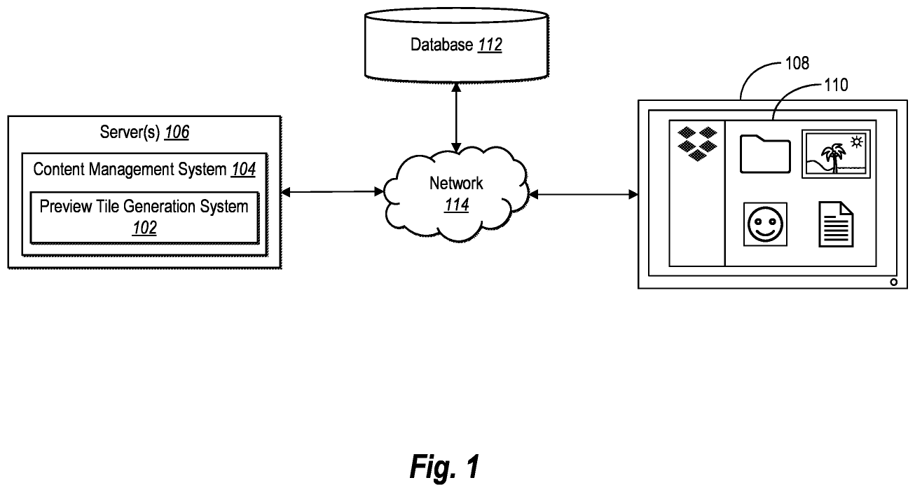

Additional details regarding the preview tile generation system will now be provided with reference to the figures. For example, FIG. 1 illustrates a block diagram of a system environment for implementing a preview tile generation system in accordance with one or more embodiments. An overview of the preview tile generation system is described in relation to FIG. 1. Thereafter, a more detailed description of the components and processes of the preview tile generation system is provided in relation to subsequent figures.

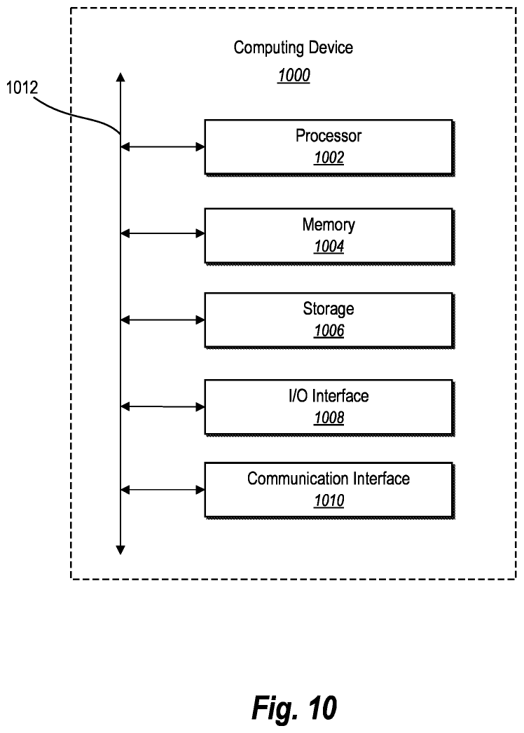

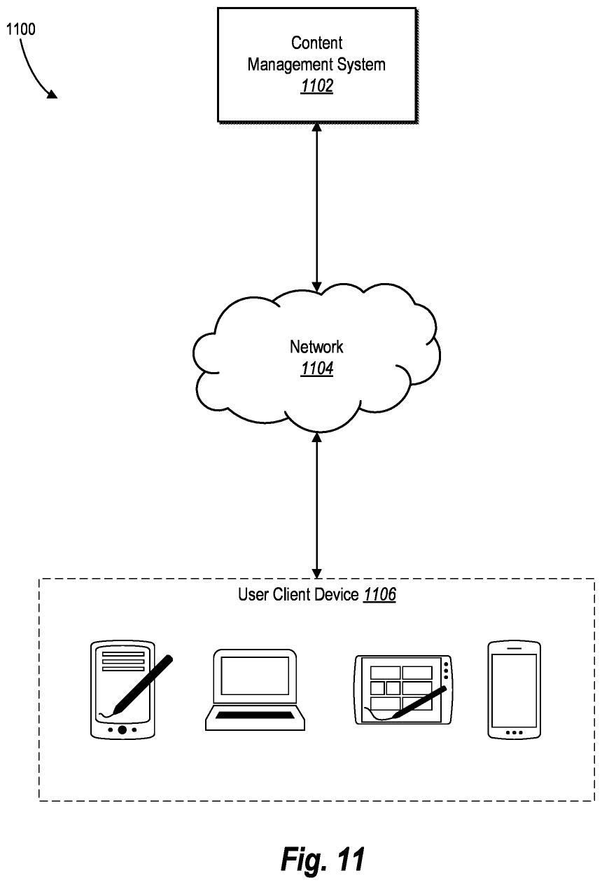

As shown, the environment includes server(s) 106, which stores or houses content management system 104, preview tile generation system 102, client device 108, and database 112. Each of the components of the environment can communicate via network 114, and network 114 may be any suitable network over which a computing device can communicate. Example networks are discussed in more detail below in relation to FIGS. 10-11.

As mentioned above, the example environment includes client device 108. The client device 108 can be one of a variety of computing devices, including a smartphone, a tablet, a smart television, a desktop computer, a laptop computer, a virtual reality device, an augmented reality device, or another computing device as described in relation to FIGS. 10-11. The client device 108 can communicate with the server(s) 106 via network 114. For example, client device 108 can receive user input from a user interacting with client device 108 (e.g., via client application 110) to, for instance, receive indications of a user input of an input location relative to a preview tile (e.g., through a cursor hover). In addition, the preview tile generation system 102 or the server(s) 106 can receive information relating to various interactions with content items and/or user interface elements based on input received by client device 108.

As shown, the client device 108 can include a client application 110. In particular, the client application 110 may be a web application, a native application installed on client device 108 (e.g., a mobile application, a desktop application, etc.), or a cloud-based application where all or part of the functionality is performed by the server(s) 106. Based on instructions from client application 110, client device 108 can present or display information, including a user interface for interacting with preview tiles. Using the client application 110, the client device 108 can perform (or request to perform) various operations, such as displaying various hotspot frames within the preview tile.

As illustrated in FIG. 1, the example environment also includes the server(s) 106. The server(s) 106 may generate, track, store, process, receive, and transmit electronic data, such as preview tiles and/or data related to generating a preview tile, hotspot frame data, content item segments, content item data, input locations (or interactions) relative to a preview tile, and/or interactions between user accounts or client devices. For example, the server(s) 106 may receive an indication from the client device 108 of an input location relative to a preview tile. In addition, the server(s) 106 can transmit data to the client device 108 in the form of a preview tile. Indeed, the server(s) 106 can communicate with the client device 108 to send and/or receive data via network 114. In some implementations, the server(s) 106 comprise(s) a distributed server where the server(s) 106 include(s) a number of server devices distributed across the network 114 and located in different physical locations. The server(s) 106 can comprise one or more content servers, application servers, container orchestration servers, communication servers, web-hosting servers, machine learning servers, and other types of servers.

As shown in FIG. 1, the server(s) 106 can also include the preview tile generation system 102 as part of the content management system 104. The content management system 104 can communicate with the client device 108 to perform various functions associated with the client application 110, such as managing user accounts, accessing content items, and opening (or rendering) content items. Indeed, content management system 104 can include a network-based smart cloud storage system to manage, store, and maintain content items and related data across numerous user accounts. In some embodiments, the preview tile generation system 102 and/or the content management system 104 utilize the database 112 to store and access information such as content items, content item segments, cached data for rendering a preview tile, and other information.

Although FIG. 1 depicts the preview tile generation system 102 located on the server(s) 106, in some implementations, the preview tile generation system 102 may be implemented by (e.g., located entirely or in part on) one or more other components of the environment. For example, the preview tile generation system 102 may be implemented as part of client device 108 and/or a third-party system. As another example, the client device and/or a third-party system can download all or part of the preview tile generation system 102 for implementation independent of, or together with, the server(s) 106.

In some implementations, though not illustrated in FIG. 1, the environment may have a different arrangement of components and/or may have a different number or set of components altogether. For example, the client device 108 may communicate directly with the preview tile generation system 102, bypassing network 114. The environment may also include one or more third-party systems, each corresponding to a different data source. In addition, the environment can include the database 112 located external to the server(s) 106 (e.g., in communication via the network 114) or located on the server(s) 106 and/or on the client device 108.

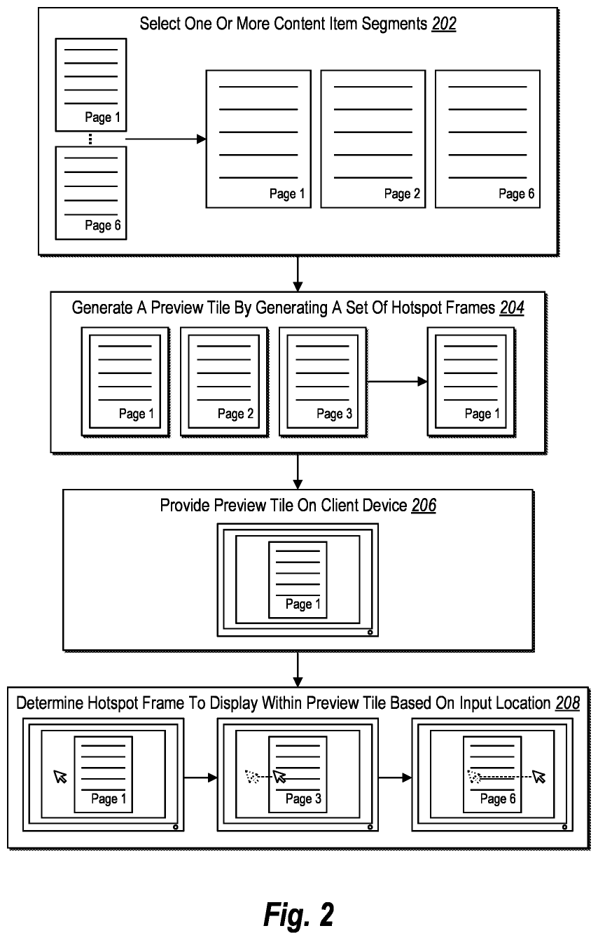

As mentioned, the preview tile generation system 102 generates a preview tile comprising hotspot frames corresponding to digital content within a content item. In particular, the preview tile generation system 102 selects content item segments corresponding to portions of a content item and generates a preview tile by generating hotspot frames that reflect the digital content in the content item. FIG. 2 illustrates an example diagram of an overview of the preview tile generation system generating a preview tile in accordance with one or more embodiments. Additional detail regarding the various acts illustrated in FIG. 2 is provided thereafter with reference to the subsequent figures.

As illustrated in FIG. 2, the preview tile generation system 102 performs an act 202 and selects one or more content item segments. In particular, the preview tile generation system 102 selects one or more content item segments from a content item stored for a user account within a content management system. For example, the preview tile generation system 102 intelligently identifies and selects portions of digital content from within the content item that, when displayed as hotspot frames in the preview tile, represent or indicate the content item (e.g., to aid in identifying the content item or specific content within the content item). To illustrate, a portion of content can include an image (or rendering of an image), a frame from a digital video, an image (or rendering) of a document (e.g., a PDF or a text document), or other depiction of the type of content item (e.g., an icon of a folder) and/or the digital content within the content item.

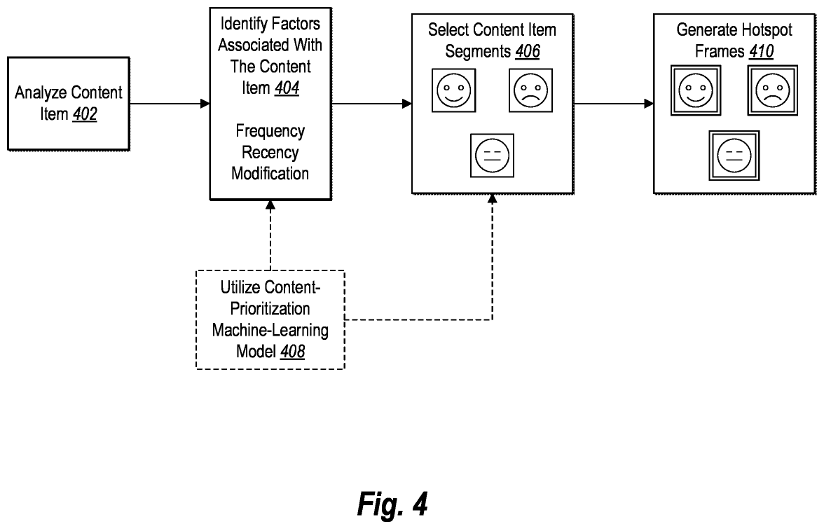

In one or more embodiments, the preview tile generation system 102 selects content item segments based on information or data associated with the content item. For example, the preview tile generation system can select content item segments based on the size of the content item, such as by sampling or selecting content item segments at intervals based on the length or size of the content item. In addition, in one or more embodiments, the preview tile generation system selects content item segments based on the content item or digital content within the content item. For example, the preview tile generation system identifies that a content item is a folder and selects content item segments to reflect content items stored within the folder. In some cases, the preview tile generation system can utilize an access timestamp by selecting content item segments from content items that a client most recently accessed. Additional detail regarding the preview tile generation system 102 selecting content item segments based on information or data associated with the content item is discussed further with respect to FIG. 4 below.

Additionally, in one or more embodiments, the preview tile generation system 102 selects content item segments based on content items or portions of a content item that the preview tile generation system anticipates a client device will likely access. In some cases, the preview tile generation system utilizes a content prioritization machine-learning model to generate a likelihood that a client device will access digital content within the content item and select content item segments according to the likelihood. In other cases, the preview tile generation system selects content item segments based on identifying that a content item (or portion of the content item) comprises or corresponds to requested user action from the client device and selects content item segments comprising the requested user action. Additional information regarding preview tile generation system 102 selecting content item segments based on the portions of the content item that the client device will likely access is discussed further with respect to FIG. 4 below.

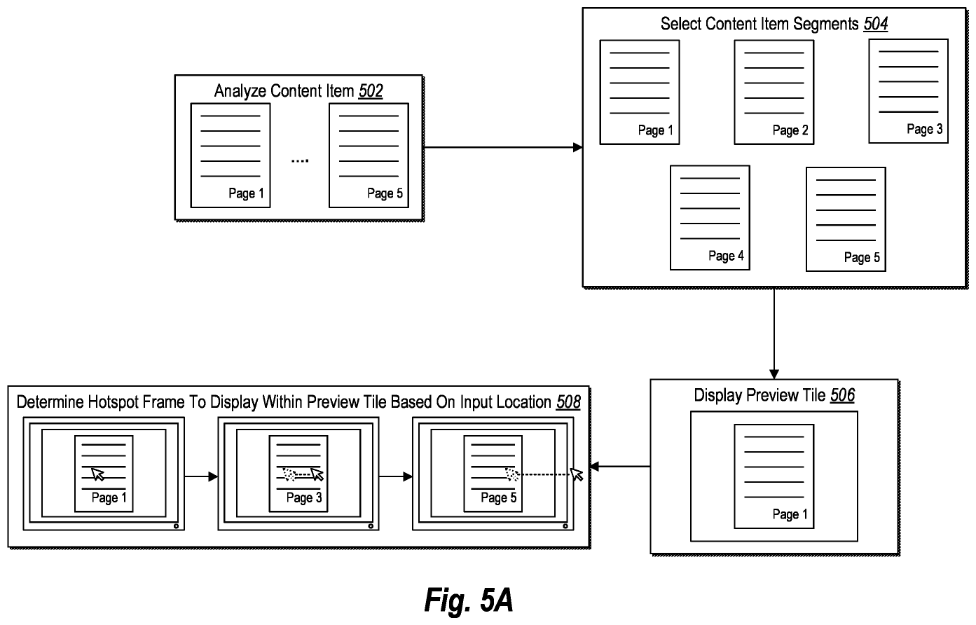

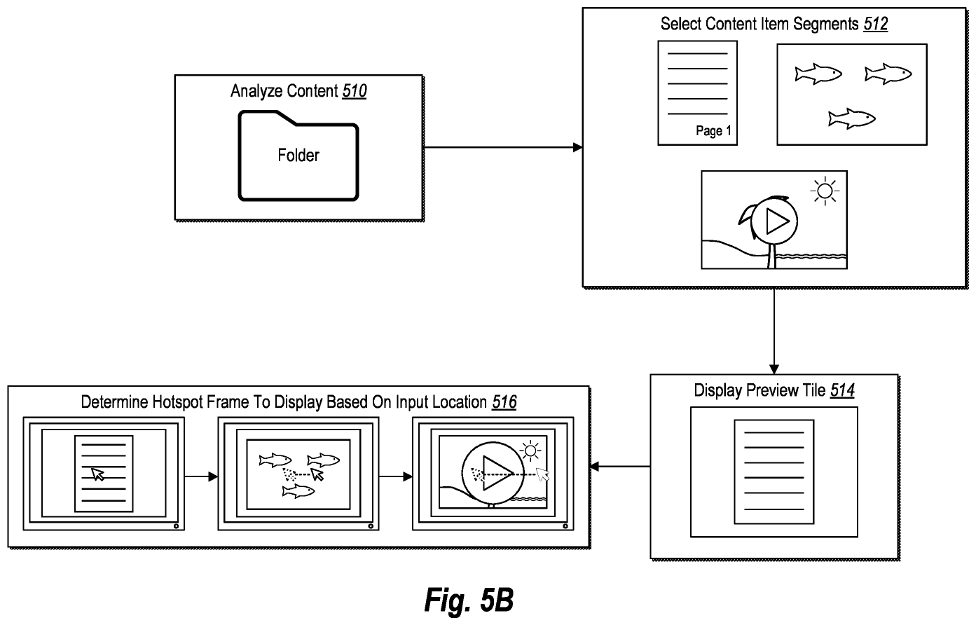

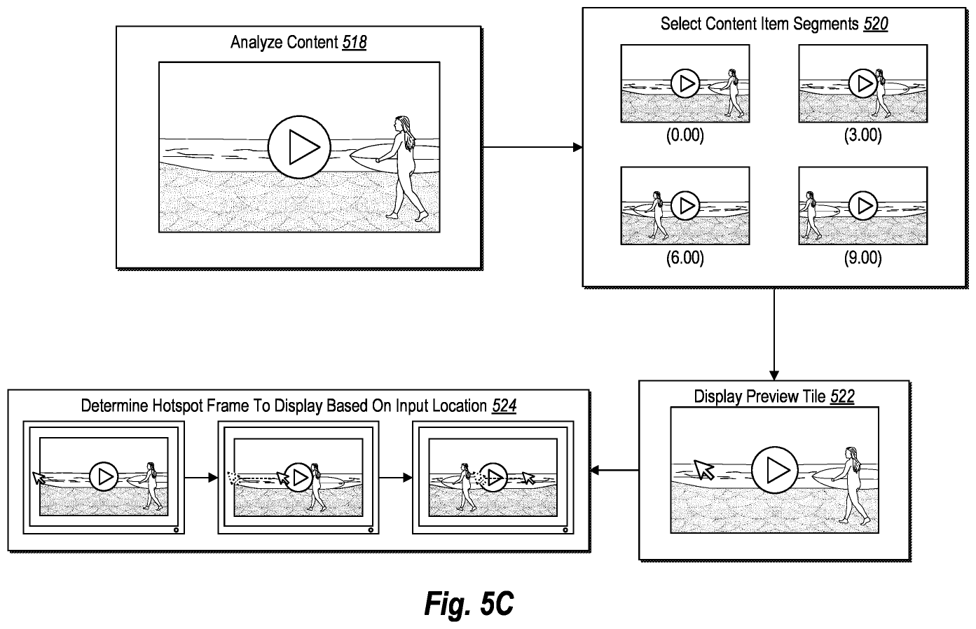

Further, in one or more embodiments, the preview tile generation system selects content item segments based on the content item. In particular, the preview tile generation system, the preview tile generation system selects content item segments based on the type of content item or on information or data associated with the content item. For example, the preview tile generation system can select content item segments based on the size of the content item, such as by sampling or selecting content item segments at intervals based on the length or size of the content item. In addition, in some cases, the preview tile generation system selects content item segments based on the content item or digital content within the content item. For example, the preview tile generation system identifies that a content item is a folder and selects content item segments to reflect content items stored within the folder. Additional information regarding the preview tile generation system selecting content item segments based on the type of content item or information or data associated with the content item is discussed further with respect to FIGS. 5A-5C below.

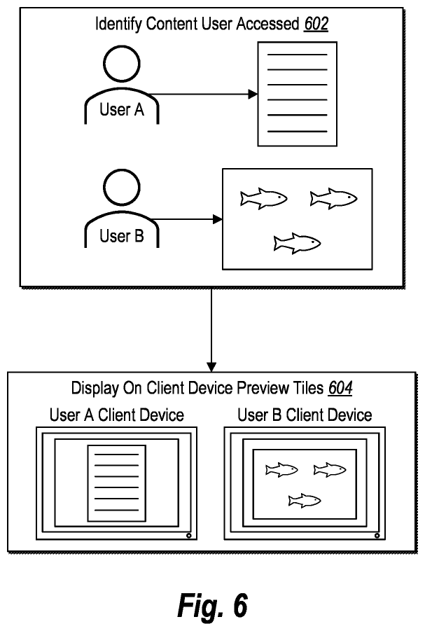

Moreover, in one or more embodiments, the preview tile generation system 102 selects content item segments based on one or more user accounts associated with the content item. In particular, the preview tile generation system can identify that a client device associated with a user account accessed or modified a content item (or certain content modified within the content item) and select content item segments based on the accessed or modified content. In some cases, the preview tile generation system identifies that a content item is associated with multiple user accounts and selects content item segments based on identifying content items (or portions of digital content within a content item) accessed by the client device associated with the preview tile. Additional information regarding the preview tile generation system 102 selecting content items based on a user account is discussed further with respect to FIG. 6 below.

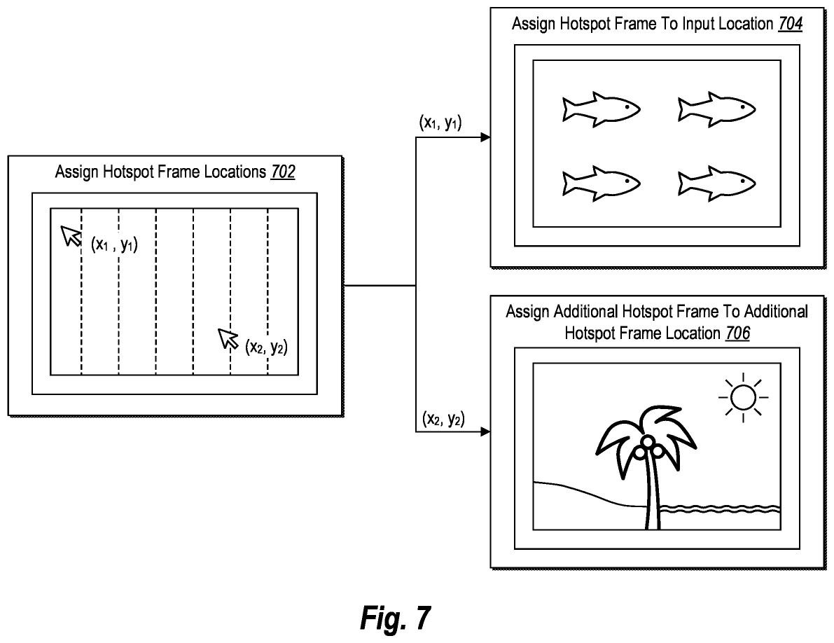

As further illustrated in FIG. 2, the preview tile generation system 102 performs an act 204 and generates a preview tile. In particular, the preview tile generation system 102 generates a preview tile by generating a set of hotspot frames to reflect digital content in the content item segments. For example, each hotspot frame can reflect (or comprise) the digital content selected from the content item. Moreover, the preview tile generation system 102 associates (or correlates) locations within the preview tile to hotspot frames from the set of hotspot frames. Generating a set of hotspot frames and associating the hotspot frames to locations within the preview tile will be discussed further with respect to FIG. 7 below.

As also illustrated in FIG. 2, the preview tile generation system 102 performs an act 206 and provides the preview tile for display on a client device associated with the user account. In particular, the preview tile generation system 102 provides the preview tile in a user interface of a content management system. For example, the preview tile generation system 102 can provide the preview tile in place of a preview icon in the user interface of the content management system. In some cases, the preview tile generation system 102 can provide a preview tile based on the content item or type of content item. Additional detail regarding the preview tile generation system 102 providing the preview tile on a client device is discussed further with respect to FIGS. 5A-5B below.

As shown in FIG. 2, the preview tile generation system 102 performs an act 208 and determines a hotspot frame to display based on input location. Specifically, the preview tile generation system 102 receives an input location from a client device (e.g., a cursor location) and determines to display a hotspot frame based on the input location. For example, as the preview tile generation system 102 receives input locations (e.g., by receiving different cursor locations from a client device), the preview tile generation system 102 can display different hotspot frames based on the different input locations. To illustrate, as shown in FIG. 2, upon receiving input locations going from the left to right, respectively, within a preview tile, the preview tile generation system 102 determines t hotspot frames to display based on the different input locations.

In one or more embodiments, the preview tile generation system 102 associates or assigns input locations to hotspot frame locations so that when the preview tile generation system 102 receives the input location, it will display the associated hotspot frame. Specifically, the preview tile generation system 102 associates input locations to hotspot frame locations so that, upon receiving the hotspot frame location, the preview tile generation system 102 will display a hotspot frame corresponding to the hotspot frame location. For example, the preview tile generation system 102 associates hotspot frames with hotspot frame locations that correspond to coordinates with the preview tile and, upon receiving the coordinates matching the hotspot frame location, will display the associated hotspot frame. Additional detail regarding the preview tile generation system 102 associating hotspot frames to hotspot frame locations is discussed further with respect to FIG. 7 below.

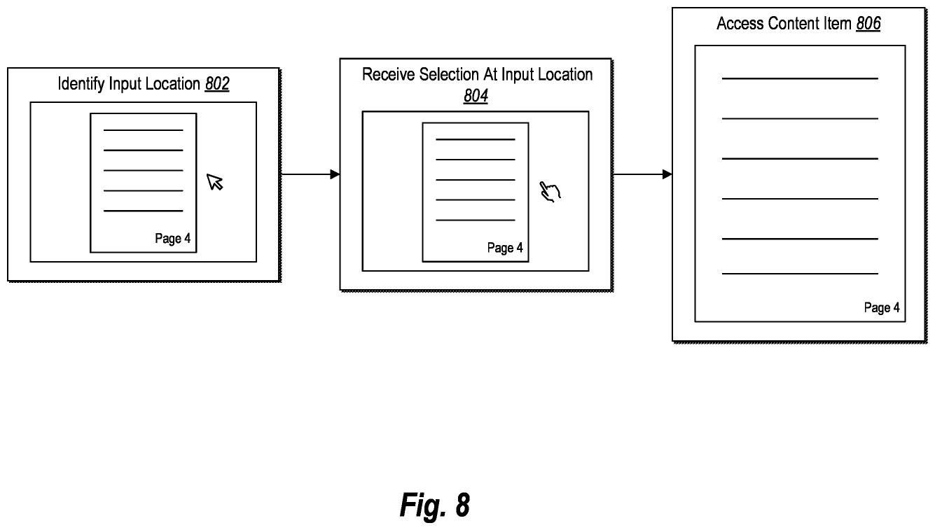

In one or more embodiments, the preview tile generation system 102 accesses a content item based on receiving a selection within the preview tile. Specifically, the preview tile generation system 102 can receive a selection from a client device while displaying a hotspot frame in the preview tile and access (e.g., open) the content item based on the displayed hotspot frame. For example, the preview tile generation system 102 receives a selection from the client device without receiving a further input location (e.g., without moving the cursor) and accesses the content item. In some cases, the preview tile generation system 102 displays the content item at a location within the content item associated with the hotspot frame. Additional detail regarding the preview tile generation system 102 accessing content items based on selection at input location is discussed further with respect to FIG. 8 below.

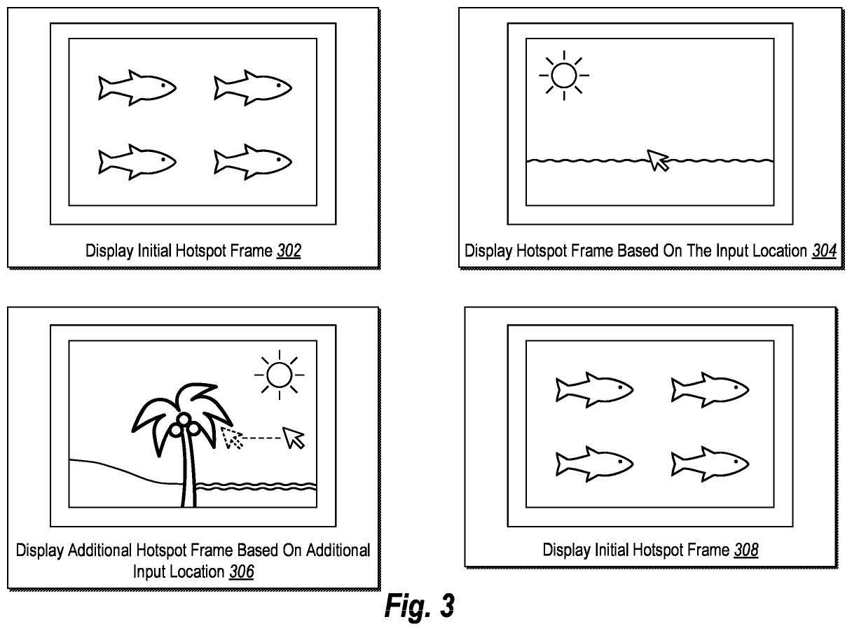

As previously mentioned, the preview tile generation system 102 determines a hotspot frame to display in a preview tile. In particular, the preview tile generation system 102 receives an input location from a client device and determines a hotspot frame to display within the preview tile based on the input location. FIG. 3 illustrates an example diagram of the preview tile generation system 102 displaying a hotspot frame within a preview tile based on an input location in accordance with one or more embodiments.

As shown, the preview tile generation system 102 can perform an act 302 and display an initial hotspot frame in the preview tile. An initial hotspot frame refers to a hotspot frame displayed within a preview tile upon generating a preview tile (e.g., prior to receiving an input location). For example, the preview tile generation system 102 displays an initial hotspot frame as an indication of the content item. In one or more embodiments, the preview tile generation system 102 selects an initial hotspot frame by displaying a hotspot frame corresponding to an initial portion of a content item. In some cases, the preview tile generation system 102 selects an initial hotspot frame based on timestamp (e.g., the hotspot frame corresponds to a content item segment at the beginning of the content item).

In one or more embodiments, the preview tile generation system 102 selects an initial hotspot frame based on identifying that digital content reflected in the hotspot frame represents the content item. Specifically, the preview tile generation system 102 analyzes the content item to determine portions of the content item that comprise data, user interactions, or other information that, when displayed in the preview tile, represent the content item. For example, the preview tile generation system 102 selects the initial hotspot frame based on recency, such as by identifying a portion of the content item that was recently accessed by a client device associated with the content item (e.g., based on timestamp). As another example, the preview tile generation system 102 selects the initial hotspot frame based on identifying that a client device associated with the content modified the content item (or a portion of the content item) and selecting the initial hotspot frame to include the modified content item (or modified portion of the content item).

Additionally, in one or more embodiments, preview tile generation system 102 determines an initial frame based on a frequency associated with how often a client device accesses the content item. For example, if the preview tile generation system 102 identifies that, upon accessing the content item, the client device frequently accesses a portion of a content item, the preview tile generation system 102 can utilize a hotspot frame reflecting that portion of the content item as the initial hotspot frame. In some cases, the preview tile generation system 102 can determine that an access frequency associated with the content item (or portions of the content item) is above an access threshold. In other cases, the preview tile generation system 102 identifies that the access frequency associated with that portion of the content item is a certain amount above the other portions of the content item (e.g., accessed 50% more than other portions of the content item)

As shown in FIG. 3, the preview tile generation system 102 performs an act 304 and determines a hotspot frame to provide for display based on input location. In particular, the preview tile generation system 102 receives an input location based on a user interaction with a client device indicating an input location relative to the preview tile. For example, the preview tile generation system 102 can receive an input location by receiving a cursor location (e.g., through a mouse, keyboard, or movement on a mobile device) relative to the preview tile. To illustrate, the preview tile generation system 102 can receive an input location by detecting the placement of a cursor on the preview tile (e.g., without selection from the mouse, keyboard, or mobile device).

In one or more embodiments, upon receiving an input location, the preview tile generation system 102 determines a hotspot frame to display within the preview tile. In particular, the preview tile generation system 102 identifies that the input location corresponds to a hotspot frame location and displays a hotspot frame associated with the hotspot frame location. In some cases, as indicated by FIG. 3, the preview tile generation system 102 identifies that the hotspot frame location is associated with an additional hotspot frame (e.g., other than the initial hotspot frame) and updates the preview tile to display the additional hotspot frame. In other cases, the preview tile generation system 102 identifies that the hotspot frame location corresponds to the initial hotspot frame and maintains the display of the initial hotspot frame.

As shown in FIG. 3, the preview tile generation system 102 performs an act 306 and determines an additional hotspot frame to provide for display based on an additional input location. In particular, the preview tile generation system 102 receives an additional input location based on receiving an additional (or updated) user interaction with the client device that indicates an additional input location relative to the preview tile. For example, the preview tile generation system 102 can receive an additional input location by identifying a user input from the client device that moves the location of a cursor relative to the preview tile.

In one or more embodiments, the preview tile generation system 102 identifies that the additional input location corresponds to an additional hotspot frame location and determines an additional hotspot frame to display within the preview tile. Specifically, the preview tile generation system 102 identifies an additional input location corresponding to an additional hotspot frame location and updates the preview tile to display an additional hotspot frame associated with the additional hotspot frame location. For example, the preview tile generation system 102 identifies that a cursor location (e.g., a hover location of a cursor) within the preview tile moved from a first input location corresponding to a first hotspot frame location to a second input location corresponding to a second hotspot frame location and updating the preview tile from a first hotspot frame to a second hotspot frame. Additional detail regarding hotspot frame locations and moving a cursor within a preview will be discussed further with respect to FIG. 7 below.

As additional input locations are received (e.g., through the movement of a cursor), the preview tile generation system 102 updates the display upon receiving additional input locations. Specifically, the preview tile generation system 102 selects content item segments and generates hotspot frames prior to receiving a user interaction indicating an input location so that the preview tile generation system 102 displays a hotspot frame in the preview tile within milliseconds of upon receiving a user interacting indicating an input location. Moreover, as the preview tile generation system 102 receives additional input locations, the preview tile generation system 102 can display hotspot frames associated with the corresponding hotspot location. For example, as illustrated in FIG. 3, for user input from a client device that moves a cursor from left to right, the preview tile generation system 102 displays hotspot frames that identify different portions of content (e.g., scrubs through the content to identify various points in the content).

As illustrated in FIG. 3, the preview tile generation system 102 performs an act 308 and displays an initial hotspot frame. In particular, the preview tile generation system 102 identifies that there is no longer user interaction with a client device at the input location and displays the initial hotspot frame. For example, the preview tile generation system 102 identifies a user interaction with a client device that moves a cursor from the preview tile and updates the preview tile to display the initial hotspot frame. In some cases, the preview tile generation system 102 identifies that a hotspot frame associated with an input location is the initial hotspot frame and determines to maintain displaying the initial hotspot frame upon detecting that there is no longer user interaction with a client device at the input location.

As mentioned, the preview tile generation system 102 selects content item segments from a content item. In particular, the preview tile generation system 102 analyzes a content item and selects content item segments that reflect meaningful portions of the content item. FIG. 4 illustrates an example diagram of the preview tile generation system selecting content item segments from a content item in accordance with one or more embodiments.

As illustrated in FIG. 4, the preview tile generation system 102 performs an act 402 and analyzes a content item. Specifically, the preview tile generation system 102 analyzes the content item to identify data and/or information associated with the content item. For example, the preview tile generation system 102 analyzes a content item to identify the length of a content item based on the content item. To illustrate, identifying length can include the page length for a document, the time length or number of frames for a digital video, or the number of content items in a folder.

In some cases, the preview tile generation system 102 analyzes a content item to identify a user account associated with a content item and/or information about a user account associated with a content item. For example, the preview tile generation system 102 can identify the type of user account (e.g., paid account vs. free account), whether the user account is associated with a collaborating user account group, client devices associated with the user account, and/or data associating the user account to the content item.

Moreover, in some embodiments, the preview tile generation system 102 can analyze the content item to identify information and/or data about the digital content in the content item. For example, the preview tile generation system 102 can identify areas or portions of the content item that do not contain digital content (i.e., a blank page in a document, a frame in a digital video with few images). Indeed, the preview tile generation system 102 identifies areas or portions of different types of content items differently, as will be discussed further with respect to FIGS. 5A-5C.

As illustrated in FIG. 4, the preview tile generation system 102 can perform act 404 and identify factors associated with the content item. In particular, the preview tile generation system 102 identifies factors associated with the content item that indicate that a client device is more likely to identify the content item and/or access the content item. For example, a factor can include data or metadata associated with a content item that indicate a state or identifier of the content item that the preview tile generation system 102 can utilize to identify whether a client device is more likely to identify and/or access the content item.

In one or more embodiments, the preview tile generation system 102 identifies factors by determining a frequency associated with the content item. In particular, the preview tile generation system 102 determines a frequency by identifying how often a client device (or multiple client devices) accessed a content item. For example, the preview tile generation system 102 determines an access frequency associated with a content item. To illustrate, for a content item that is a folder comprising a set of additional content items, the preview tile generation system 102 can determine an access frequency reflecting the number of times a client device accessed each content item within the set of content items.

Moreover, the preview tile generation system 102 can determine an access frequency for portions of a document. Specifically, the preview tile generation system 102 can determine an access frequency based on how many times a client device (or multiple client devices) accessed a specific portion of a document (or multiple portions of a document). For example, the preview tile generation system 102 can determine that upon opening a document, a client device typically scrolls to and/or modifies a certain page. As another example, the preview tile generation system 102 can identify that upon opening a digital video, a client device typically interacts with a certain frame.

In one or more embodiments, the preview tile generation system 102 can identify factors associated with a content item by identifying a recency associated with a content item. In particular, the preview tile generation system 102 can utilize a timestamp associated with a content item to identify how recently a client device interacted with the content item. For example, the preview tile generation system 102 can identify a timestamp associated with when a client device last opened a content item or when a client device last modified a content item. Moreover, the preview tile generation system 102 identifies when a client device last accessed and/or modified a portion of a content item, such as a page in a document or a frame in a digital video.

Additionally, the preview tile generation system 102 can determine factors based on modification of the content item. Specifically, the preview tile generation system 102 identifies that a client device (or multiple client devices) modifies a certain portion of the content item more than other portions of the content item. For example, the preview tile generation system 102 can determine that a number of modifications to a portion of the content item (e.g., a page in a document, a frame in a digital video) is higher than other portions of the content item. As another example, the preview tile generation system 102 identifies that a measure of the modifications of the portion of the content item is a threshold amount above other portions of the document (e.g., 30% more modifications or 20 more instances of modifications).

As illustrated in FIG. 4, the preview tile generation system 102 performs an act 406 and selects content item segments. In particular, the preview tile generation system 102 selects content item segments that are representative of the content item. For example, preview tile generation system 102 selects a portion of a content item (e.g., a page of a document, a frame of a digital video, and/or a content item stored in a folder) as a content item segment and when all content item segments are taken together, are representative of the digital contents of the content item.

In one or more embodiments, the preview tile generation system 102 selects content item segments based on the size and/or length of the content item. In particular, the preview tile generation system 102 selects content item segments based on the size and/or length of the content item and with a potential number of hotspot frame locations. For example, the preview tile generation system 102 identifies that, based on the length of a content item, a potential number of content item segments in the content item matches the number of hotspot frame locations and selects all the potential content item segments. As another example, the preview tile can identify that there are fewer potential content item segments than potential hotspot frame locations and determine to select all potential content item segments and assign an equal number of hotspot frame locations (e.g., larger hotspot frame locations). As a further example, the preview tile generation system 102 identifies that the number of potential content item segments exceeds the number of hotspot frame locations and chooses content item segments accordingly. To illustrate, for a document comprising one hundred pages and a preview tile with a capacity for twenty hotspot frame locations, the preview tile generation system 102 can determine to select every fifth portion of the content item as a content item segment.

In addition, in one or more embodiments, the preview tile generation system 102 selects content item segments based on the factors identified in act 404 and/or content information identified when analyzing the content item in act 402. Specifically, the preview tile generation system 102 can determine, based on the factors and/or content information, that a portion of the content item indicates that a client device associated with the content item is more likely to access the content item. For example, the preview tile generation system 102 selects content item segments based on an access frequency of the content item by selecting a number of content item segments most frequently accessed by the client device (e.g., the 20 most frequently accessed by the client device. As another example, the preview tile generation system 102 selects content item segments based on recency by selecting a number of content item segments most recently accessed by the client device (e.g., the 20 most recently accessed portions of the content item). As a further example, the preview tile generation system 102 selects content item segments based on modifications by selecting content item segments based on portions of the content item that comprise modifications (e.g., the 20 most recently modified portions of the content item). In one or more embodiments, the preview tile generation system 102 utilizes a combination (e.g., a weighted combination) of the factors from act 404 and the information from act 402 to select content item segments.

Moreover, in one or more embodiments, the preview tile generation system 102 can determine not to select a portion of a content item as a content item segment. In particular, the preview tile generation system 102 determines that a portion of the content item does not comprise digital content. For example, the preview tile generation system 102 can utilize third-party recognition systems to identify portions of a content item that do not comprise digital content (e.g., optical character recognition or digital video recognition systems). In some cases, the preview tile generation system 102 will determine to move to the proceeding portion of the content item (e.g., next page or next frame). In other cases, the preview tile generation system 102 will determine to select fewer content item segments.

As illustrated in FIG. 4, the preview tile generation system 102 can also optionally perform step 408 and utilize a content prioritization machine-learning model. In one or more embodiments, the preview tile generation system 102 selects content item segments in act 406 based on the output of a content prioritization system. Specifically, the preview tile generation system 102 provides the factors identified in act 404 and/or the information gained from analyzing the content item in act 402 as features for input into the content prioritization machine-learning model, and the content prioritization machine-learning model outputs a likelihood that a client device will access the content item. The preview tile generation system 102 then selects content item segments based on the likelihood that a client device will access the content item. In one or more embodiments, the preview tile generation system 102 can elect to utilize the content prioritization machine-learning model when selecting content item segments, such as based on the status of the user account associated with the content item (e.g., the type of user account or whether the account is a paid account).

As illustrated in FIG. 4, the preview tile generation system 102 can perform an act 410 and generate hotspot frames. In particular, the preview tile generation system 102 generates hotspot frames that reflect digital content in the content item segments selected in act 406 by generating an image of the digital content in the content item segments. For example, the preview tile generation system 102 generates (or renders) an image of each of the content item segments that are the size (e.g., pixel width and height) of the preview tile (or the viewable area of the preview tile). In some cases, the preview tile generation system 102 will crop the image to fit the preview tile. In other cases, the preview tile generation system 102 will layer the image on a white background to generate the hotspot frame.

In one or more embodiments, the preview tile generation system 102 preview tile generation system 102 selects a graphical representation of the content item for the hotspot frame. In particular, the preview tile generation system 102 can utilize the graphical representation of the content item within the hotspot frame to identify the type of content item. For example, the preview tile generation system 102 can utilize a graphical representation in lieu of an image in a hotspot frame to represent a content item that is not easily represented by an image of the content (e.g., a folder storing additional content item). As another example, the preview tile generation system 102 overlays the graphical representation on the image in the hotspot frame to indicate the content item type (e.g., a play button overlaid on an image of a digital video frame to indicate the content item is a digital video).

As previously mentioned, the preview tile generation system 102 generates preview tiles across various content item types. In particular, the preview tile generation system 102 intelligently identifies and selects content item segments based on the type of content item and generates preview tiles that can display hotspot frames to reflect the content from the various content item types through simple and intuitive client device interactions. FIGS. 5A-5C illustrate example diagrams of the preview tile generation system generating a preview tile for various types of content items in accordance with one or more embodiments. Specifically, FIG. 5A illustrates an example diagram of the preview tile generation system 102 selecting content item segments and displaying a preview tile for a document (e.g., a PDF, text document, slide deck), FIG. 5B illustrates an example diagram of the preview tile generation system 102 selecting content item segments and displaying a preview tile for a folder, and FIG. 5C illustrates an example diagram of the preview tile generation system 102 selecting content item segments and displaying a preview tile for a digital video.

As illustrated in FIG. 5A, the preview tile generation system 102 performs an act 502 and analyzes the content item. In addition to all the steps of analyzing a content item described above in reference to FIG. 4 (e.g., act 402), the preview tile generation system 102 can identify the type of content item, which is a document in this example. Specifically, for a document, the preview tile generation system 102 identifies (or determines) the type of document of the content item. For example, the preview tile generation system 102 can determine whether a document is a PDF, a text document (e.g., a Word document or other text-based document), or a slide deck. The preview tile generation system 102 can also identify if the document is stored within the content management system and edited by third-party software (e.g., a Word document stored within the content management system) or if the document is edited with a cloud-based editing system (e.g., Google Docs or Dropbox Paper).

As further illustrated in FIG. 5A, the preview tile generation system 102 performs an act 504 and selects content item segments. In particular, the preview tile generation system 102 selects content item segments for a document based on pages or other defining characteristics of the document. For example, in instances where the document has distinct pagination, the preview tile generation system 102 will select content item segments by selecting pages of the document based on the factors associated with the document (e.g., frequency, recency, and/or modification) and/or utilizing a content prioritization machine-learning model. As another example, in instances where the document does not comprise distinct pagination (e.g., documents edited on cloud-based editing systems), the preview tile generation system 102 will select content item segments based on other breaks in the document, such as graphics or by selecting a certain amount of text (and graphics) within the document.

Moreover, in one or more embodiments, the preview tile generation system 102 utilizes a recognition system to identify the contents of the document. In particular, the preview tile generation system 102 selects content item segments based on information received from recognition systems that identify content within a document. For example, the preview tile generation system 102 can utilize optical character recognition to identify characters and information in a document or to identify portions of a document that do not comprise digital content (e.g., are blank or are close to blank).

As further illustrated in FIG. 5A, the preview tile generation system 102 performs an act 506 and displays a preview tile. Specifically, the preview tile generation system 102 displays a preview with a corresponding initial hotspot frame. For example, the preview tile generation system 102 can determine an initial hotspot frame for a document by selecting the hotspot frame corresponding to the first page of the document, as shown. In another example, the preview tile generation system 102 selects an initial hotspot frame based on other factors, such as frequency, recency, modifications, a likelihood that a client device will identify access the content item, and/or a combination of factors.

As also illustrated in FIG. 5A, the preview tile generation system 102 performs an act 508 and determines a hotspot frame to display within the preview tile based on input location. Specifically, the preview tile generation system 102 can display hotspot frames corresponding to representative portions of the content item based on the input location, where identifying successive input locations along the preview displays hotspot frames in a manner that is representative of the document. For example, as illustrated, the preview tile generation system 102 displays an initial hotspot frame of the first page of the document, receives an input location by receiving a user interaction by moving the cursor to the right relative to the preview tile, and displays the hotspot frame associated with the hotspot frame location of the input location (e.g., page 3). As the preview tile generation system 102 identifies an additional input location relative to the preview tile by receiving an additional user moving the cursor further to the right relative to the preview tile, the preview tile generation system 102 displays a hotspot frame associated with the hotspot frame location of the additional input location (e.g., page 5). Indeed, as illustrated, through this simple and intuitive user interaction with a preview tile, the preview tile generation system 102 provides an overview of a document, allowing for the identification of digital contents within a document without the need to open and/or sift through the document.

As illustrated in FIG. 5B, the preview tile generation system 102 performs an act 510 and analyzes the content item. In addition to all the steps of analyzing a content item described above in reference to FIG. 4 (e.g., act 402), the preview tile generation system 102 can identify the type of content item, which is a folder in this example. Specifically, for a folder storing content items for a user account of a content management system, the preview tile generation system 102 determines the various content items stored within the folder. For example, the preview tile generation system 102 identifies content type and/or digital content for content items stored in the folder.

As further illustrated in FIG. 5B, the preview tile generation system 102 performs an act 512 and selects content item segments. In particular, when the content item is a folder, the preview tile generation system 102 selects content item segments by selecting a single content item segment from each content item stored within the folder. For example, the preview tile generation system 102 selects a content item segment that is representative of the content item based on factors associated with each content item (e.g., frequency, recency, and/or modifications) and/or a likelihood that the client device will access the content item.

As also illustrated in FIG. 5B, the preview tile generation system 102 performs an act 514 and displays the preview tile. In one or more embodiments, when the content item is a folder, the preview tile generation system 102 displays an initial hotspot frame as a graphical representation indicating that the content item is a folder. For example, the preview tile generation system 102 can display a hotspot frame of an icon of a folder. In one or more embodiments, when the content item is a folder, the preview tile generation system 102 displays the preview tile with an initial hotspot frame corresponding to the content item within the folder that a client device is most likely to access. For example, based on factors associated with each content item within the folder (e.g., frequency, recency, and/or modifications), the preview tile generation system 102 can determine a content item in the folder that a client device is likely to access and display a hotspot frame corresponding to the content item.

As also illustrated in FIG. 5B, the preview tile generation system 102 performs an act 516 and determines a hotspot frame to display based on input location. Specifically, the preview tile generation system 102 displays hotspot frames corresponding to content item segments representing content items stored in the folder. For example, as illustrated, the preview tile generation system 102 receives an input location (e.g., through an initial placement of a cursor) and displays a hotspot frame of a document. Upon identifying an additional user interaction based on receiving a user interaction with the client device (e.g., that moves the cursor to the right relative to the preview tile), the preview tile generation system 102 displays a hotspot frame associated with an additional content item (e.g., an image). As the preview tile generation system 102 identifies a further input location by receiving a further user interaction with the client device (e.g., that moves the cursor further to the right relative to the preview tile), the preview tile generation system 102 displays a further hotspot frame associated with a further content item (e.g., a digital video). Indeed, as illustrated, through this simple and intuitive user interaction with a preview tile, the preview tile generation system 102 provides an overview of a document, allowing for the identification of content items within a folder without the need to open and/or sift through the folder.

As illustrated in FIG. 5C, the preview tile generation system 102 performs an act 518 and analyzes the content item. In addition to all the steps of analyzing a content item described above in reference to FIG. 4 (e.g., act 402), the preview tile generation system 102 can identify the type of content item, which is a digital video in this example. For example, for a digital video, preview tile generation system 102 determines the length of the digital video or frames in the digital video.

As further illustrated in FIG. 5C, the preview tile generation system 102 performs an act 520 and selects content item segments. Specifically, when the content item is a digital video, the preview tile generation system 102 selects content item segments by selecting frames throughout the length of the digital video that are representative of the digital video. For example, the preview tile generation system 102 can select frames based on the length of the digital video. To illustrate, for a 10-minute-long digital video for a preview tile that can accommodate 20 hotspot frames, the preview tile generation system 102 will select a frame at 30-second intervals along the length of the digital video.

Moreover, in some embodiments, the preview tile generation system 102 selects content item segments in the digital video based on the digital contents within the digital video. In particular, the preview tile generation system 102 can utilize frame recognition systems that detect, identify, or track objects, people, actions, or events in a digital video and select content item segments by selecting frames that comprise the identified objects, people, actions, or events. For example, the preview tile generation system 102 can utilize an object detection system that identifies or locates specific objects or entities with a digital video and selects content item segments based on identifying an object. As another example, the preview tile generation system 102 can utilize a face recognition system that identifies (or tracks) faces in a digital video and selects content item segments based on an identified face. As a further example, the preview tile generation system 102 utilizes a gesture recognition system that detects and understands hand movements or body gestures in each frame and selects content item segments based on the detected gestures. As an even further example, the preview tile generation system 102 utilizes event detection systems that identify specific events or anomalies with a digital video and selects content item segments based on the detected events or anomalies.

As also illustrated in FIG. 5C, the preview tile generation system 102 performs an act 522 and displays the preview tile. In one or more embodiments, when the content item is a digital video, the preview tile generation system 102 displays an initial hotspot frame representing the digital video and an overlay of a graphic indicating the content item is a digital video. For example, the preview tile generation system 102 displays an initial hotspot frame for a digital video by displaying the first frame of a digital video. As another example, the preview tile generation system 102 displays an initial hotspot frame by displaying a frame that is representative of the digital video based on factors associated with the digital video or from frame recognition systems that identify representative frames in a digital video.

As further illustrated in FIG. 5C, the preview tile generation system 102 performs an act 524 and determines a hotspot frame to display based on input location. Specifically, the preview tile generation system 102 displays hotspot frames corresponding to content item segments representing the digital video. For example, as illustrated, the preview tile generation system 102 receives an input location (e.g., through an initial placement of a cursor) and displays a hotspot frame of a frame of the digital video. Upon identifying an additional user interaction based on receiving a user interaction with the client device (e.g., that moves the cursor to the right relative to the preview tile), the preview tile generation system 102 displays a hotspot frame associated with an additional frame of the digital video. As the preview tile generation system 102 identifies a further input location by receiving a further user interaction with the client device (e.g., that moves the cursor further to the right relative to the preview tile), the preview tile generation system 102 displays a further hotspot frame associated with the digital video. Indeed, as illustrated, through this simple and intuitive user interaction with a preview tile, the preview tile generation system 102 provides an overview of a digital video, allowing for a visual representation of the contents of the digital video without the need to open or watch the digital video.

As previously mentioned, the preview tile generation system 102 can display preview tiles based on a user account. In particular, the preview tile generation system 102 identifies content accessed by a user account and displays hotspot frames in the preview tile that reflect digital content accessed by the user account. FIG. 6 illustrates an example of the preview tile generation system displaying hotspot frames in preview tile based on user account in accordance with one or more embodiments.

As illustrated in FIG. 6, the preview tile generation system 102 performs an act 602 and identifies content accessed by a user account. In particular, the preview tile generation system 102 identifies that a content item is associated with a collaborating user account group and determines content that users of the collaborating user account group accessed. For example, as illustrated, the preview tile generation system 102 identifies that User A, through a client device associated with User A, accessed a content item (or portion of a content item). Moreover, the preview tile generation system 102 identifies that User B, through a client device associated with User B, accessed an additional content item (or portion of an additional content item).

As illustrated in FIG. 6, the preview tile generation system 102 performs an act 604 and displays preview tiles on client devices. In particular, the preview tile generation system 102 displays preview tiles on client devices that reflect content accessed by the client device. For example, as illustrated, the preview tile generation system 102 displays hotspot frames in the preview tile on a client device associated with User A that reflect content accessed by User A and displays hotspot frames in the preview tile on a client device associated with User B that reflect content accessed by User B.

As previously mentioned, the preview tile generation system 102 assigns hotspot frame locations to locations within the preview tile. In particular, the preview tile generation system 102 assigns or identifies coordinates to the preview tile and assigns hotspot frame locations to coordinates within the preview tile. FIG. 7 illustrates an example diagram of assigning locations within the preview tile to hotspot frames in accordance with one or more embodiments.

As illustrated in FIG. 7, the preview tile generation system 102 performs an act 702 and assigns hotspot frame locations within the preview tile. In particular, the preview tile generation system 102 assigns hotspot frame locations based on coordinates within the preview tile. For example, the preview tile generation system 102 assigns coordinates corresponding to locations within the preview tile to hotspot frame locations. As illustrated, in some embodiments, the preview tile generation system 102 assigns hotspot frame locations by identifying coordinates so that upon detecting input locations (e.g., by placement or movement of a cursor), the preview tile generation system 102 will display hotspot frames. In some cases, as the cursor moves in a specified direction (e.g., right to left), the preview tile generation system 102 will display in the hotspot frames in order of the content item (e.g., in order of the pages of a document or the frames of a digital video).

In one or more embodiments, the preview tile generation system 102 comprises an animation frame that detects an input location based on a user interaction with the preview tile on the client device. Specifically, the animation frame comprises (x,y) coordinates, and upon detecting input locations relative to the preview tile (e.g., upon detecting cursor locations within the animation frame), performs an operation and upon an unmount from the animation frame (e.g., removing the cursor from the animation frame), the animation frame cancels the operation. For example, the preview tile generation system 102 generates an animation frame within the preview tile and displays hotspot frames based on receiving input locations of user interactions with the animation frame.

As illustrated, the preview tile generation system 102 performs an act 704 and assigns a hotspot frame to a hotspot location. Moreover, the preview tile generation system 102 performs an act 706 and assigns an additional hotspot frame to an additional hotspot location. Though these are illustrated as separate acts, these acts may be performed in sequence or at the same time.

In one or more embodiments, the preview tile generation system 102 assigns hotspot frames to hotspot frame locations in a way that user interactions in a certain direction relative to the preview tile will display hotspot frames in an ordered manner. For example, as shown, the preview tile generation system 102 can assign coordinates in a column-like fashion so that input locations going horizontally (e.g., moving a cursor right-to-left or left-to-right) will result in preview tile generation system 102 displaying different hotspot frames. The preview tile generation system 102 can also assign coordinates in a row-like fashion so that input locations going vertically (e.g., moving a cursor top-to-bottom or bottom-to-top) will result in the preview tile generation system 102 displaying different hotspot frames.

As mentioned, the preview tile generation system 102 accesses a content item based on receiving a selection of the preview tile at an input location. In particular, the preview tile generation system 102 accesses a content item at a location in the content item corresponding to the hotspot frame displayed in the preview tile. FIG. 8 illustrates the preview tile generation system accessing a content item based on the input location in the preview tile in accordance with one or more embodiments.

As illustrated in FIG. 8, the preview tile generation system 102 performs an act 802 and identifies an input location. In particular, the preview tile generation system 102 receives user input from a client device at an input location (e.g., by a cursor placement or movement of a cursor) and displays a hotspot frame based on the input location, as described above.

As further illustrated in FIG. 8, the preview tile generation system 102 performs an act 804 and receives a selection at an input location. Specifically, the preview tile generation system 102 receives an indication of a selection at the input location in the preview tile that indicates a client device is attempting to access the content item. For example, while receiving an input location need only receive an indication of user input from a client device of a location (e.g., the placement of a cursor), receiving an indication of a selection at an input location can be a different set of movements from a client device that indicate selection. To illustrate, the selection can be a tap of a client device associated with a cursor (e.g., on a mouse or trackpad), a keyboard keypress, or a touch interaction on a mobile screen that indicates a selection.

As also illustrated in FIG. 8, the preview tile generation system 102 performs an act 806 and accesses a content item. In particular, the preview tile generation system 102 accesses (or opens) a content item at a location within the content item corresponding to the displayed hotspot frame. For example, as shown, the preview tile generation system 102 received the selection at the input location corresponding to a hotspot frame location for page four of a document and accessed the content item by opening up to page 4. In one or more embodiments, the preview tile generation system 102 relies on interactions between application programming interfaces to open the content item at a specified location within the content item. In some cases, the preview tile generation system 102 sends an instruction to an application programming interface for the content item to open the content item at a specified location.

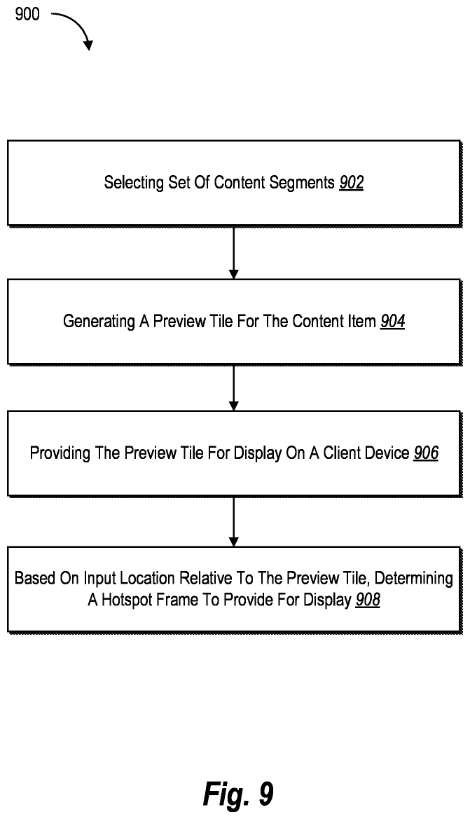

FIGS. 1-8, the corresponding text, and the examples provide a number of different methods, systems, devices, and non-transitory computer-readable media of the preview tile generation system 102. In addition to the foregoing, one or more embodiments can also be described in terms of flowcharts comprising acts for accomplishing a particular result, as shown in FIG. 9. FIG. 9 may be performed with more or fewer acts. Further, the acts may be performed in differing orders. Additionally, the acts described herein may be repeated or performed in parallel with one another or parallel with different instances of the same or similar acts.

As mentioned, FIG. 9 illustrates a flowchart of a series of acts 900 for generating and displaying a preview tile in accordance with one or more embodiments. While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer-readable medium can comprise instructions that, when executed by one or more processors, cause a computing device to perform the acts of FIG. 9. In some embodiments, a system can perform the acts of FIG. 9.

As shown in FIG. 9, the series of acts 900 includes an act 902 of selecting a set of content segments, an act 904 of generating a preview tile for the content item, an act 906 of providing the preview tile for display on a client device, and an act 908 of determining a hotspot frame to provide for display.

In particular, the act 902 can include selecting, from a content item stored for a user account within a content management system, a set of content item segments to include within a preview for the content item, the act 904 can include generating a preview tile for the content item by generating a set of hotspot frames to reflect digital content within each content item segment of the set of content item segments, the act 906 can include providing the preview tile for display on a client device associated with the user account, and the act 908 can include based on an input location relative to the preview tile, determining a hotspot frame from the set of hotspot frames to provide for display within the preview tile.

For example, in one or more embodiments, the series of acts 900 includes receiving an additional input location relative to the preview tile and based on the additional input location, determining an additional hotspot frame from the set of hotspot frames to provide for display within the preview tile.

In addition, in one or more embodiments, the series of acts 900 includes generating the preview tile by associating hotspot frames of the set of hotspot frames to hotspot frame locations within the preview tile, determining the hotspot frame to provide for display within the preview tile by identifying that the input location relative to the preview tile corresponds to a hotspot frame location and an associated hotspot frame, and providing the associated hotspot frame for display within the preview tile based on identifying that the input location relative to the preview tile corresponds to the hotspot frame location.

Moreover, in one or more embodiments, the act 904 includes identifying that the content item is a folder comprising a set of additional content items, determining an access frequency associated with content items in the set of additional content items reflecting a number of times the client device accessed the content items within the set of additional content items, and selecting the set of content item segments by selecting content item segments from the set of additional content items to include within the preview tile for the folder based on the access frequency. In one or more embodiments, the act 904 further includes identifying access timestamps for each content item in the set of additional content items reflecting when the client device accessed the content item and generating the preview tile by associating hotspot frames of the set of hotspot frames to hotspot frame locations within the preview tile based on access time timestamp.

Additionally, in one or more embodiments, the series of acts 900 includes identifying that the user account within the content management system is associated with a collaborating user account group comprising at least an additional user account, selecting the set of content item segments based on identifying that a client device associated with the user account accessed the content item and selecting an additional set of content item segments based on identifying that an additional client device associated with the additional user account accessed an additional content item, generating the preview tile by generating hotspot frames utilizing the set of content item segments and generating an additional preview tile by generating additional hotspot frames for the additional set of content item segments, and providing the preview tile for display on the client device and the additional preview tile for display on the additional client device.

Further, in one or more embodiments, the series of acts 900 includes determining a number of hotspot frames to display within the preview tile and selecting the set of content item segments based on the number of hotspot frames. In one or more embodiments, the series of acts 900 includes selecting the set of content item segments by selecting digital content from the content item at interval points in the content item corresponding to the number of hotspot frames.

In addition, in one or more embodiments, the series of acts 900 includes determining, utilizing a content-prioritization machine learning model, a likelihood that the client device will access digital content within the content item and selecting the set of content item segments based on the likelihood that the client device associated with the user account will access the digital content within the content item.

Moreover, in one or more embodiments, the series of acts 900 includes receiving, within the preview tile, a selection of the hotspot frame at the input location and accessing the content item based on a content item segment associated with the hotspot frame at the input location.

Additionally, in one or more embodiments, the series of acts 900 includes identifying that the client device associated with a user account modified a portion of the content item, based on identifying that the client device associated with the user account modified the portion of the content item, selecting the set of content item segments from the portion of the content item, and generating the set of hotspot frames to reflect digital content within the set of content item segments from the portion of the content item.

Further, in one or more embodiments, the series of acts 900 includes identifying that the content item is a folder comprising a set of additional content items, selecting the set of content item segments by selecting content item segments from content items of the set of additional content items, and generating the set of hotspot frames to reflect digital content within the set of content item segments from the set of additional content items.

Moreover, in one or more embodiments, the series of acts 900 includes determining that the content item corresponds to a requested user action from the client device associated with the user account, selecting the set of content item segments by selecting one or more content item segments comprising the requested user action, generating the preview tile by generating a hotspot frame to reflect content item segments comprising the requested user action and an indication of the requested user action, and providing the preview tile for display on the client device with the indication of the requested user action.

In addition, in one or more embodiments, the series of acts 900 includes determining, utilizing a content prioritization machine learning model, a likelihood that the client device will access digital content within the content item and selecting the set of content item segments based on the likelihood that the client device associated with the user account will access the digital content within the content item.

Also, in one or more embodiments, the series of acts 900 includes determining a number of hotspot frames to display within the preview tile based on a size of the content item and selecting the set of content item segments based on the number of hotspot frames.

Further, in one or more embodiments, the series of acts 900 includes identifying an access timestamp for the content item reflecting when the client device accessed the content item and providing the set of hotspot frames for display within the preview tile by arranging the set of hotspot frames corresponding to content item according to the access timestamp.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 10 illustrates a block diagram of an example computing device 1000 that may be configured to perform one or more of the processes described above. One will appreciate that one or more computing devices, such as the computing device 1000 may represent the computing devices described above (e.g., server(s) 106, client device 108, and computing device 1006). In one or more embodiments, the computing device 1000 may be a mobile device (e.g., a mobile telephone, a smartphone, a PDA, a tablet, a laptop, a camera, a tracker, a watch, a wearable device, etc.). In some embodiments, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example, and not by way of limitation, the storage device 1006 can include a non-transitory storage medium described above. The storage device 1006 may include a hard disk drive (HDD), flash memory, a Universal Serial Bus (USB) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can include hardware, software, or both that connects components of computing device 1000 to each other.

FIG. 11 is a schematic diagram illustrating environment 1100 within which one or more implementations of the preview tile generation system 102 can be implemented. For example, the preview tile generation system 102 may be part of a content management system 1102 (e.g., the content management system 104). Content management system 1102 may generate, store, manage, receive, and send digital content (such as digital content items). For example, content management system 1102 may send and receive digital content to and from client devices 1106 by way of network 1104. In particular, content management system 1102 can store and manage a collection of digital content. Content management system 1102 can manage the sharing of digital content between computing devices associated with a plurality of users. For instance, content management system 1102 can facilitate a user sharing a digital content with another user of content management system 1102.

In particular, content management system 1102 can manage synchronizing digital content across multiple client devices 1106 associated with one or more users. For example, a user may edit digital content using client device 1006. The content management system 1102 can cause client device 1006 to send the edited digital content to content management system 1102. Content management system 1102 then synchronizes the edited digital content on one or more additional computing devices.

In addition to synchronizing digital content across multiple devices, one or more implementations of content management system 1102 can provide an efficient storage option for users that have large collections of digital content. For example, content management system 1102 can store a collection of digital content on content management system 1102, while the client device 1006 only stores reduced-sized versions of the digital content. A user can navigate and browse the reduced-sized versions (e.g., a thumbnail of a digital image) of the digital content on client device 1006. In particular, one way in which a user can experience digital content is to browse the reduced-sized versions of the digital content on client device 1006.

Another way in which a user can experience digital content is to select a reduced-size version of digital content to request the full- or high-resolution version of digital content from content management system 1102. In particular, upon a user selecting a reduced-sized version of digital content, client device 1006 sends a request to content management system 1102 requesting the digital content associated with the reduced-sized version of the digital content. Content management system 1102 can respond to the request by sending the digital content to client device 1006. Client device 1006, upon receiving the digital content, can then present the digital content to the user. In this way, a user can have access to large collections of digital content while minimizing the amount of resources used on client device 1006.

Client device 1006 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1006 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1104.

Network 1104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1106 may access content management system 1102.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
selecting, from a content item stored for a user account within a content management system, a set of content item segments to include within a preview for the content item;
generating a preview tile for the content item by generating a set of hotspot frames to reflect digital content within each content item segment of the set of content item segments;
providing the preview tile for display on a client device associated with the user account; and
based on an input location relative to the preview tile, determining a hotspot frame from the set of hotspot frames to provide for display within the preview tile.

2. The computer-implemented method of claim 1, further comprising:
receiving an additional input location relative to the preview tile; and
based on the additional input location, determining an additional hotspot frame from the set of hotspot frames to provide for display within the preview tile.

3. The computer-implemented method of claim 1, further comprising:
generating the preview tile by associating hotspot frames of the set of hotspot frames to hotspot frame locations within the preview tile;
determining the hotspot frame to provide for display within the preview tile by identifying that the input location relative to the preview tile corresponds to a hotspot frame location and an associated hotspot frame; and
providing the associated hotspot frame for display within the preview tile based on identifying that the input location relative to the preview tile corresponds to the hotspot frame location.

4. The computer-implemented method of claim 1, wherein generating the preview tile further comprises:
identifying that the content item is a folder comprising a set of additional content items;
determining an access frequency associated with content items in the set of additional content items reflecting a number of times the client device accessed the content items within the set of additional content items; and
selecting the set of content item segments by selecting content item segments from the set of additional content items to include within the preview tile for the folder based on the access frequency.

5. The computer-implemented method of claim 4, further comprising:
identifying access timestamps for each content item in the set of additional content items reflecting when the client device accessed the content item; and
generating the preview tile by associating hotspot frames of the set of hotspot frames to hotspot frame locations within the preview tile based on access time timestamp.

6. The computer-implemented method of claim 1, further comprising:
identifying that the user account within the content management system is associated with a collaborating user account group comprising at least an additional user account;
selecting the set of content item segments based on identifying that a client device associated with the user account accessed the content item and selecting an additional set of content item segments based on identifying that an additional client device associated with the additional user account accessed an additional content item;
generating the preview tile by generating hotspot frames utilizing the set of content item segments and generating an additional preview tile by generating additional hotspot frames for the additional set of content item segments; and
providing the preview tile for display on the client device and the additional preview tile for display on the additional client device.

7. The computer-implemented method of claim 1, further comprising:
determining a number of hotspot frames to display within the preview tile; and
selecting the set of content item segments based on the number of hotspot frames.

8. The computer-implemented method of claim 7, further comprising selecting the set of content item segments by selecting digital content from the content item at interval points in the content item corresponding to the number of hotspot frames.

9. The computer-implemented method of claim 1, further comprising:
determining, utilizing a content-prioritization machine learning model, a likelihood that the client device will access digital content within the content item; and
selecting the set of content item segments based on the likelihood that the client device associated with the user account will access the digital content within the content item.

10. The computer-implemented method of claim 1, further comprising:
receiving, within the preview tile, a selection of the hotspot frame at the input location; and
accessing the content item based on a content item segment associated with the hotspot frame at the input location.

11. A non-transitory computer-readable medium storing instructions that, when executed by at least one processor, cause a computer system to:
select, from a content item stored for a user account within a content management system, a set of content item segments to include within a preview for the content item;
generate a preview tile for the content item by generating a set of hotspot frames to reflect digital content within the set of content item segments;
provide the preview tile for display on a client device associated with the user account; and
based on an input location relative to the preview tile, determine a hotspot frame from the set of hotspot frames to provide for display within the preview tile.

12. The non-transitory computer-readable medium of claim 11, further comprising instructions that, when executed by the at least one processor, cause the computer system to:
receive an additional input location relative to the preview tile; and
based on the additional input location, determine an additional hotspot frame from the set of hotspot frames to provide for display within the preview tile.

13. The non-transitory computer-readable medium of claim 11, further comprising instructions that, when executed by the at least one processor, cause the computer system to:
identify that the client device associated with a user account modified a portion of the content item;
based on identifying that the client device associated with the user account modified the portion of the content item, select the set of content item segments from the portion of the content item; and
generate the set of hotspot frames to reflect digital content within the set of content item segments from the portion of the content item.

14. The non-transitory computer-readable medium of claim 11, further comprising instructions that, when executed by the at least one processor, cause the computer system to:
identify that the content item is a folder comprising a set of additional content items;
select the set of content item segments by selecting content item segments from content items of the set of additional content items; and
generate the set of hotspot frames to reflect digital content within the set of content item segments from the set of additional content items.

15. The non-transitory computer-readable medium of claim 11, further comprising instructions that, when executed by the at least one processor, cause the computer system to:
determine that the content item corresponds to a requested user action from the client device associated with the user account;
select the set of content item segments by selecting one or more content item segments comprising the requested user action;
generate the preview tile by generating a hotspot frame to reflect content item segments comprising the requested user action and an indication of the requested user action; and
provide the preview tile for display on the client device with the indication of the requested user action.

16. A system comprising:
at least one processor; and
at least one non-transitory computer-readable storage medium storing instructions that, when executed by the at least one processor, cause the system to:
select, from a content item stored for a user account within a content management system, set of content item segments to include within a preview for the content item;
generate a preview tile for the content item by generating set of hotspot frames to reflect digital content within the set of content item segments;
provide the preview tile for display on a client device associated with the user account; and
based on an input location relative to the preview tile, determine a hotspot frame from the set of hotspot frames to provide for display within the preview tile.

17. The system of claim 16, further comprising instructions that, when executed by the at least one processor, cause the system to:
receive an additional input location relative to the preview tile; and
based on the additional input location, determining an additional hotspot frame from the set of hotspot frames to provide for display within the preview tile.

18. The system of claim 16, further comprising instructions that, when executed by the at least one processor, cause the system to:
determine, utilizing a content prioritization machine-learning model, a likelihood that the client device will access digital content within the content item; and
select the set of content item segments based on the likelihood that the client device associated with the user account will access the digital content within the content item.

19. The system of claim 16, further comprising instructions that, when executed by the at least one processor, cause the system to:
determine a number of hotspot frames to display within the preview tile based on a size of the content item; and
select the set of content item segments based on the number of hotspot frames.

20. The system of claim 16, further comprising instructions that, when executed by the at least one processor, cause the system to:
identify an access timestamp for the content item reflecting when the client device accessed the content item; and
provide the set of hotspot frames for display within the preview tile by arranging the set of hotspot frames corresponding to content item according to the access timestamp.
